(19) United States
(12) Patent Application Publication
(10) Pub. No.: US 2012/0210653 A1
(43) Pub. Date: Aug. 23, 2012

(54) ROADWAY GRATING SYSTEM AND METHOD THEREOF

(75) Inventor: Hugh J. Tate, Lindenhurst, NY (US)

(73) Assignee: CONSOLIDATED EDISON COMPANY OF NEW YORK, INC., New York, NY (US)

(21) Appl. No.: 13/031,738

(22) Filed: Feb. 22, 2011

(51) Int. Cl. E02D 29/14; B29C 39/00

(52) U.S. Cl. 52/20; 264/299

(57) ABSTRACT

A grating system such as that used in roadways or sidewalks is provided. The grating system includes a support ledge having a first surface. A surface frame is arranged adjacent the first surface, the surface frame having a plurality of second surfaces defining an opening. A grating frame is coupled to the plurality of second surfaces. At least one cover is removably coupled to the grating frame.

### BACKGROUND OF THE INVENTION

The subject matter disclosed herein relates in general to a grating system and in particular to a grating system using pre-cast materials.

Gratings are used in roadways, sidewalks and other areas to provide a means of access to underground structures. Typically, the underground structure has a wall made of brick for example. The surface frame for the grating is made from concrete that is poured into a mold made on location. The surface frame includes a metal inner frame that supports a door or a grate. Once the concrete is cured, the mold is removed and the area between the wall of the underground structure and the surface frame is filled in with a material such as brick.

It should be appreciated that when the grating is positioned in areas with high volumes of traffic, the replacement of a grating may cause a substantial disruption and an inconvenience to those persons who expect to use road or sidewalk. As a result, installation personnel are often required or pressured by regulatory officials to conclude the forming of the grating as quickly as possible. Since it can take up to 30 days for concrete to cure to a desired state, the surface frame of the grating is typically still curing when vehicles resume using the roadway. As a result, the concrete does not achieve full strength, which lowers the useful life of grating. Further, the process of forming the new grating by pouring concrete on site is also very labor intensive, which makes the installation of a new roadway grating expensive.

Accordingly, while existing gratings are suitable for their intended purposes, there remains a need for a roadway system with improved life that can be installed at lower costs.

### BRIEF DESCRIPTION OF THE INVENTION

According to one aspect of the invention, a grating system is provided. The grating system includes a support ledge having a first surface. A surface frame is arranged adjacent the first surface, the surface frame having a plurality of second surfaces defining an opening. A grating frame is coupled to the plurality of second surfaces. At least one cover is removably coupled to the grating frame.

According to another aspect of the invention, another grating system is provided. The grating system includes a pre-cast concrete surface frame having an opening therethrough. At least one cover is disposed to cover at least a portion of the opening. A grating frame integral with the surface frame is provided. The grating frame including a first member having a first end adjacent the at least one cover. A second member is coupled to the first member and arranged substantially perpendicular to the first member. A first cover support is coupled to the first member adjacent the first end, the first cover support having a first lifting slot therein. A second cover support is coupled to the first member adjacent to and spaced apart from the first cover support, the second cover support having at least one lifting slot therein.

According to yet another aspect of the invention, a method of forming a grating system is provided. A mold is provided for a support frame at a location different from the location of installation, the mold having an inner surface formed by a grating frame, wherein at least a portion of the grating frame is arranged within an interior of the mold. A concrete is cast into the first mold. The concrete is cured to support traffic loads to form the support frame. The support frame is transferred to the location of installation after the concrete is cured.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a top plan view of a grating system in accordance with an embodiment of the invention;

FIG. 2 is a side elevation view of the grating system of FIG. 1;

FIG. 3 is another side elevation view of the grating system of FIG. 1;

FIG. 4 is an enlarged sectional view of an interior frame for the grating system of FIG. 1;

FIG. 5 is a perspective view of a grating system being installed in accordance with an embodiment of the invention;

FIG. 6 is another perspective view of a grating system being installed;

FIG. 7 is another perspective view of the grating system of FIG. 6 being installed; and,

FIG. 8 is a perspective view of a mold for making a grating system.

The detailed description explains embodiments of the invention, together with advantages and features, by way of example with reference to the drawings.

### DETAILED DESCRIPTION OF THE INVENTION

Roadway grating systems provide a means for personnel, such as those personnel who work for public utilities to enter and exit underground structures. As these systems are often located in roadways or in pedestrian sidewalks, embodiments of the present invention provide a grating system that may be quickly installed and the area returned to its normal intended use. Embodiments of the invention also provide advantages of a surface frame that is cured to a desired strength before installation. Embodiments of the invention also provide a grating system that is less expensive to install and has a longer useful life than a traditional grating arrangement for roadways and sidewalks.

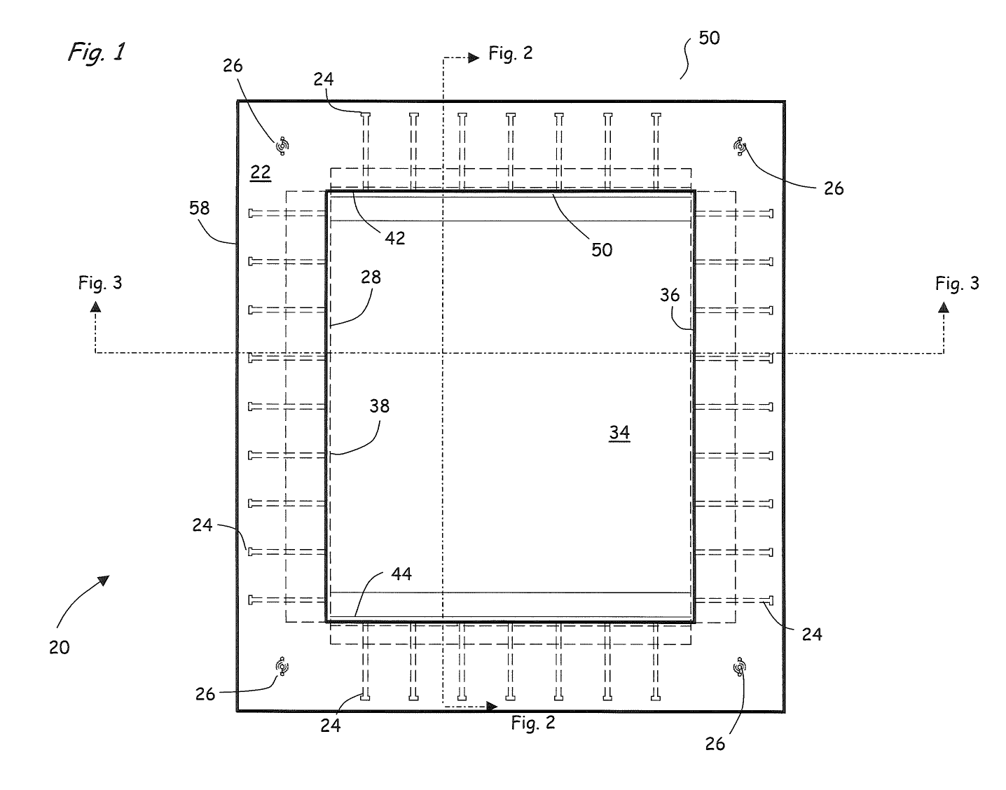

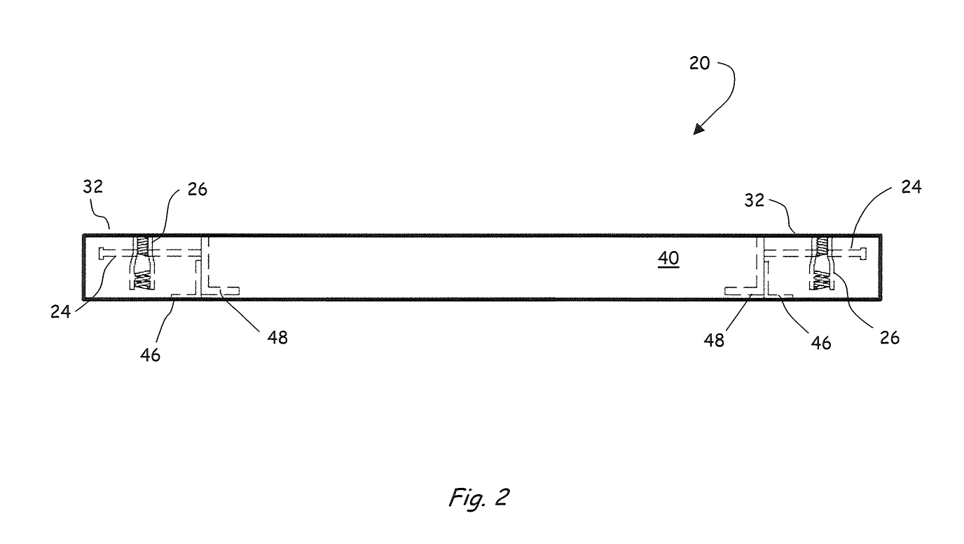

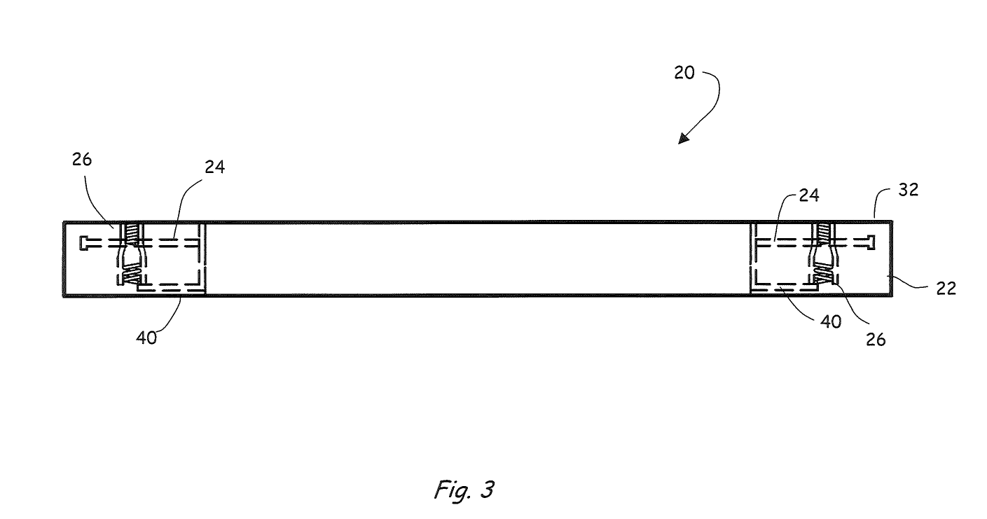

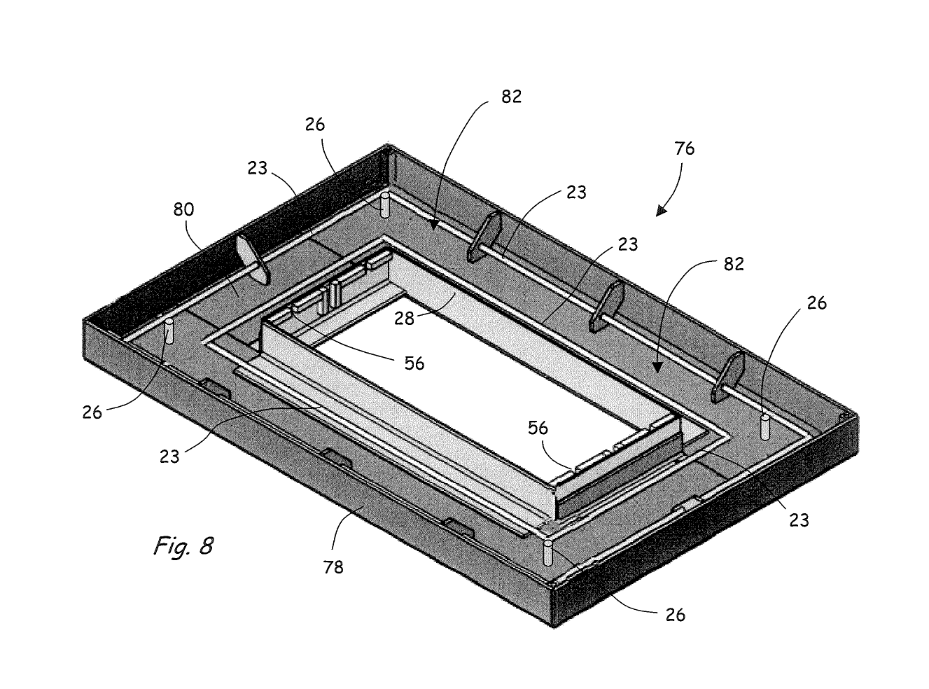

An embodiment of a grating system 20 suitable for use in a roadway is illustrated in FIGS. 1-4. The system 20 includes a surface frame 22 made from a concrete material. The concrete surface frame 22 is a precast concrete manufactured at a location away from the work site and allowed to cure to a desired strength to support roadway traffic loads. In the exemplary embodiment, the surface frame 22 has a width of 12 inches. The height of the surface frame 22 may vary depending on the type of installation. The surface frame 22 may include reinforcement materials, such as reinforcement bars 24 (rebar) such as a steel Headed Concrete Anchor stud manufactured by Nelson Stud Welding, Inc. for example. Additional rebar 23 (FIG. 8) may be arranged within the surface frame 22 to provide additional strength.

In one embodiment, the surface frame 22 includes a plurality of components 26, each disposed adjacent one corner of and imbedded in the surface frame 22. The components 26 include a threaded portion that is adapted to couple with a lifting eye. The components 26 are cast into and are integral with the surface frame 22. The component 26 may include a spiral portion that concrete flows around to improve the capturing of the component 26 within the surface frame 22. In one embodiment, the component 26 includes a plug member that is coupled to the component 26 after installation. It should be appreciated that the lifting eyes allow for a lifting device, such as a boon truck for example, to move the system 20 during installation. Once the system 20 is in place, the lifting eyes can be removed from the component 26 and the plugs reinstalled. In other embodiments, the component 26 may be welded to a grating frame 28 or a lifting eye (not shown) may be coupled to the grating frame below the to surface 32.

The system 20 further includes a grating frame 28 disposed about an opening 34 and defining the inner periphery of the surface frame 22. The grating frame 28 includes a first end 36 and a second end 38. It should be appreciated that the second end 38 is a mirror of the first end 36. The first end 36 includes a first frame member 40. In the exemplary embodiment, the first frame member 40 is a L-shaped steel angle member. A plurality of reinforcement bars 24 are welded to the first frame member 40 adjacent the surface 32.

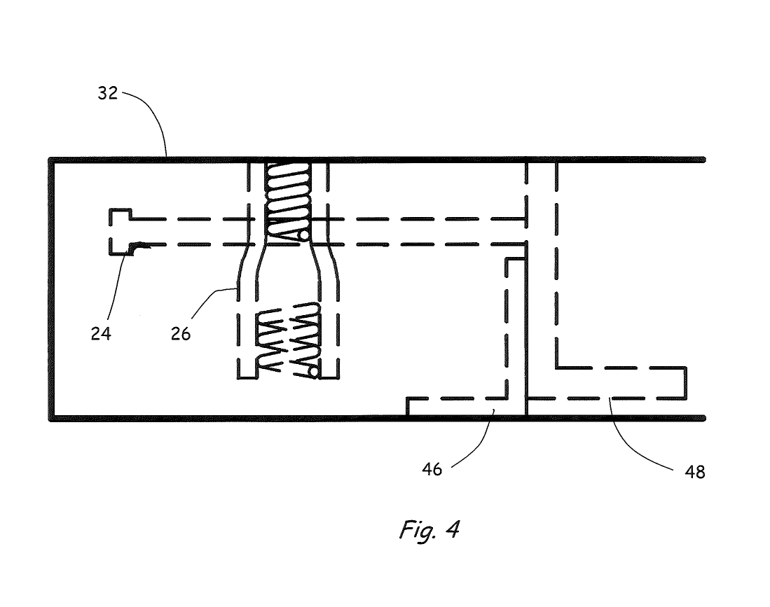

The grating frame 28 further includes a first side 42 and a second side 44. It should be appreciated that the second side 44 is a mirror of the first side 42. The first side 42 includes a second frame member 46 coupled to a third frame member 48. The second frame member 46 and third frame member 48 are coupled on each end to the first frame member 40. In one embodiment, the bottom surface of the second frame member 46 is offset from the bottom surface of the third frame member (48) (FIG. 4). The coupling of the members 40, 46, 48 may be by any suitable means such as welding for example. In the exemplary embodiment, the second frame member 46 and third frame member 48 are L-shaped steel angles. In one embodiment, the first side includes a pair of lifting eyes that are welded to the second frame member 46. In another embodiment, the first side also includes a plurality of bearing plates (not shown) having a leveling bolt. Similar to the ends 36, 38, the sides 42, 44 have a plurality of reinforcement bars 24 welded to the second frame member 46.

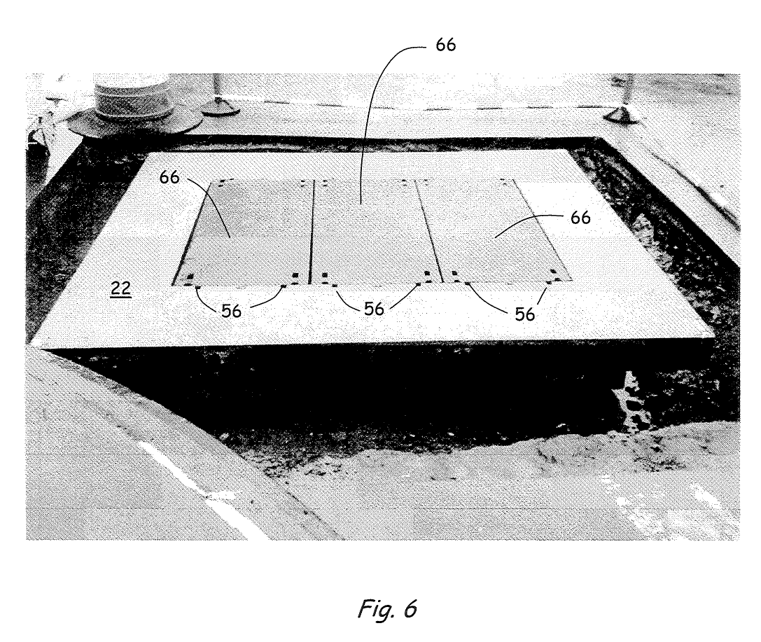

The first side may further include a cover support member 50. The cover support member 50 may be formed from the top edge of the frame member 48 for example. The cover support member may also be formed from a bar member (not shown) that is welded to the frame member 48. The cover support may include one or more slots 56 (FIG. 6) arranged adjacent the opening 34. The slot is sized to allow an operator to insert a tool (e.g. a pry-bar) beneath the cover 66 (FIG. 6) or grating. The tool allows the operator move the end of the cover or grating away from the cover support member and removed from the system 20. It should be appreciated that once the cover or grating is removed, the operator has access to the underground structure. The number of slots in the cover support member will depend on the size of the system 20 being installed.

In one embodiment, the system 20 further includes an outer frame 58 disposed about the outer periphery of the surface frame 22. The outer frame 58 is made from a steel plate. The outer frame 58 provides advantages in protecting the edge of the surface frame 22 from objects such as plow blades.

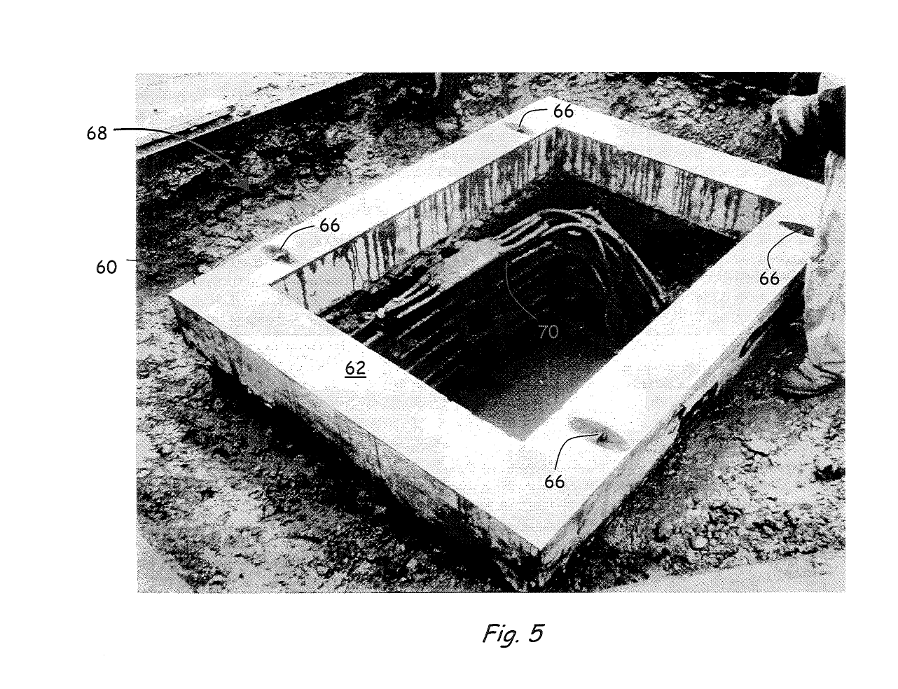

In one embodiment, the grating system 20 may further include a support ledge 60 (FIG. 5) disposed between the surface frame 22 and the underground structure. The support ledge 60 includes a generally rectangular frame having a top surface 62 that supports the surface frame 22. The support ledge 60 defines an opening that allows the operator access to the underground structure. The support ledge 60 may include one or more lifting eyes 66 to facilitate transportation and installation.

Referring now to FIGS. 5-7, the process of installing the grating system 20 will be described. The work site is first prepared by removing the old grating assembly and excavating an opening 68 around the entrance to the underground structure 70. In embodiments using the support ledge 60, the support ledge 60 is then lowered onto the underground structure 70 (FIG. 5).

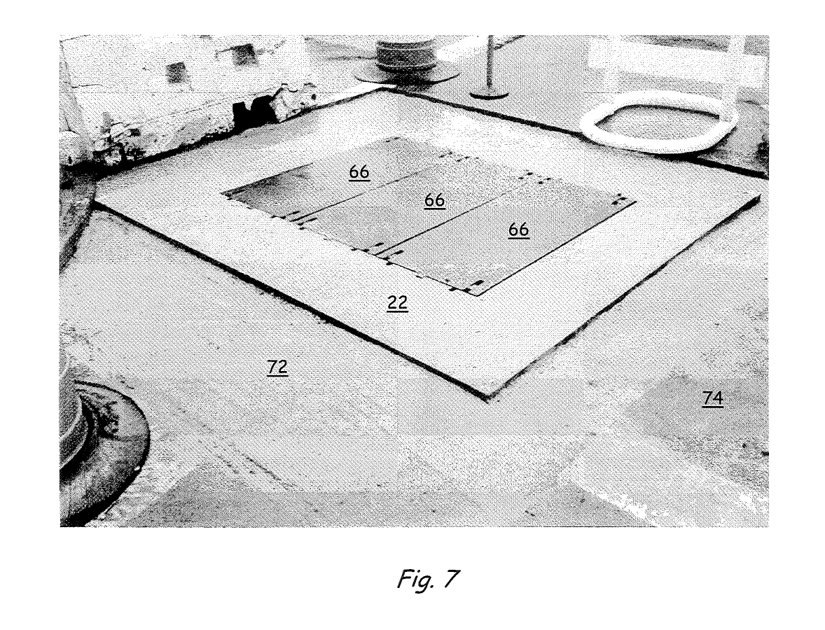

With the support ledge 60 in place, the lifting eyes may be coupled to the components 26 and the surface frame 22 lifted from the delivery vehicle. The surface frame 22 is lowered onto the support ledge 60 and centered over the opening 64 (FIG. 6). The lifting eyes may then be removed and plugs installed into the components 36. With the surface frame 22 in place, the concrete 72 may be poured into the opening 68 to fill in the gap between the surface frame 22 and the roadway 74 (FIG. 7). In one embodiment, the top surface of the concrete 72 is offset from the surface 32 and the roadway 74. The remaining gap is then filled in with asphalt (not shown) to provide a substantially smooth transition between the roadway 74 and the surface frame 22.

The use of a precast surface frame 22 and support ledge 60 provides advantages in life and cost since the concrete may be fabricated using a higher volume process rather than fabricating individually on site. Further, since the surface frame 22 and the support ledge 60 are fabricated in advance, the concrete may be cured to a desired level prior to installation. The additional curing of the concrete increases the strength and useful life of the grating system 20. In one embodiment, the surface frame 22 is cast in a first mold 76, such as the mold shown in FIG. 8.

The mold 76 includes an outer wall 78 that defines the outside surface of the surface frame 22. The inner wall is defined by the grating frame 28 with a bottom surface 80 disposed between the grating frame 28 and the outer wall 78. The grating frame 28, the bottom surface 80 and the outer wall 78 cooperate to define a volume 82 that will be filled with concrete to form the surface frame 22. Before the concrete is cast in the mold, rebar members 23 are disposed within the volume 82. Holders and other devices may be used to retain the rebar members 23 at the desired height within the volume 82. Further, the components 26 are positioned in the volume 82 and may be coupled to the rebar members 23 to prevent the components 26 from being moved by the concrete flowing into the mold 76. During the casting of the concrete, features such as the top of component 26 and the slots 56 may be masked to prevent concrete from flowing into these areas.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A grating system comprising:
a support ledge having a first surface;
a surface frame adjacent said first surface, said surface frame having a plurality of second surfaces defining an opening;
a grating frame coupled to said plurality of second surfaces; and,
at least one cover removably coupled to said grating frame.

2. The grating system of claim 1 wherein said surface frame is formed from pre-cast concrete.

3. The grating system of claim 1 wherein:
said grating frame includes a first side and a second side; and,
said grating frame is captured in said pre-cast concrete when said surface frame is formed.

4. The grating system of claim 3 wherein said grating frame includes a first plurality of lifting slots arranged on said first side.

5. The grating system of claim 4 wherein said grating frame includes a second plurality of lifting slots arranged on said second side.

6. The grating system of claim 5 wherein said at least one cover is a grate.

7. The grating system of claim 5 wherein said at least one cover includes a substantially solid surface.

8. The grating system of claim 2 further comprising a metal outer frame disposed about a periphery of the surface frame.

9. A grating system comprising:
a pre-cast concrete surface frame having an opening therethrough;
at least one cover disposed to cover at least a portion of said opening; and,
a grating frame integral with said surface frame, said grating frame including:
a first member having a first end adjacent said at least one cover;
a second member coupled to said first member and arranged substantially perpendicular to said first member;
a first cover support coupled to said first member adjacent said first end, said first cover support having a first lifting slot therein; and,
a second cover support coupled to said first member adjacent to and spaced apart from said first cover support, said second cover support having at least one lifting slot therein.

10. The grating system of claim 9 wherein said grating frame further comprises a plurality of first reinforcement bars coupled to said first member.

11. The grating system of claim 10 wherein said grating frame further comprises:
a third member coupled to said first member, said third member having a substantially L-shape and having a first surface; and,
wherein said first member has a substantially L-shape, said first member having a second surface substantially parallel to and offset from said first surface.

12. The grating system of claim 11 wherein said second member is substantially L-shaped and has a third surface arranged in parallel to said second surface.

13. The grating system of claim 12 further comprising at least one component member adapted to receive a lifting eye, said at least one component imbedded within the surface frame.

14. The grating system of claim 9 further comprising an outer frame disposed about an outer periphery of the surface frame.

15-17. (canceled)
